(19) United States
(12) Patent Application Publication
(10) Pub. No.: US 2023/0195803 A1
(43) Pub. Date: Jun. 22, 2023

(54) GIS INFORMATION RETRIEVAL METHOD USING DYNAMIC K-NEAREST NEIGHBOR SEARCH ALGORITHM IN AN OBSTACLE ENVIRONMENT

(71) Applicant: POSTECH ACADEMY-INDUSTRY FOUNDATION, Pohang-si (KR)

(72) Inventors: Hee Kap AHN, Pohang-si (KR); Jae Hoon CHUNG, Pohang-si (KR); Hwi KIM, Pohang-si (KR); Tae Kang EOM, Pohang-si (KR); Seung Jun LEE, Pohans-si (KR)

(73) Assignee: POSTECH ACADEMY-INDUSTRY FOUNDATION, Pohang-si (KR)

(21) Appl. No.: 18/084,536

(22) Filed: Dec. 19, 2022

Related U.S. Application Data
(60) Provisional application No. 63/294,069, filed on Dec. 27, 2021.

(30) Foreign Application Priority Data
Dec. 22, 2021 (KR) 10-2021-0185237

(51) Int. Cl. G06F 16/909; G06F 16/903

(52) U.S. Cl. CPC G06F 16/909; G06F 16/90335

(57) ABSTRACT

The present disclosure relates to a GIS geographical information retrieval method using a dynamic k-nearest neighbor search algorithm in an obstacle environment, which has been devised to search for geographical information by using a dynamic k-nearest neighbor search algorithm in an obstacle environment. The GIS geographical information retrieval method using a dynamic k-nearest neighbor search algorithm in an obstacle environment has an effect in that it can optimize a search time by considering obstacles as a range of angles, not discrete objects, on the basis of a query point, using the shortest path characteristics at the same time, and assigning priority to neighbors based on the calculated range of angles.

### BACKGROUND

### 1. Technical Field

The present disclosure relates to a GIS geographical information retrieval method, and more particularly, to a GIS geographical information retrieval method using a dynamic k-nearest neighbor search algorithm in an obstacle environment, which has been devised to search for geographical information by using a dynamic k-nearest neighbor search algorithm in an obstacle environment.

### 2. Related Art

In general, a GIS k-nearest neighbor search technology generates a data structure assuming that geographical information is not changed, and searches for the nearest k facilities by using the data structure. The GIS k-nearest neighbor search technology first constructs a data structure that stores geographical information, and calculates the shortest path from a query point to a destination while considering obstacles that have been sorted in order of distance and stored in the data structure when the query point is given.

For example, a navigation system performs k-nearest neighbor search in order to find the nearest gas station from a current location, and provides the shortest path to the most suitable gas station among nearby gas stations.

A conventional neighbor search algorithm that is applied to GIS search assumes a case in which all neighbors to be searched for are given in advance, generates a static data structure corresponding to the assumption, and executes a query. This has a problem in that efficiency of a computation time and memory usage is not high because a data structure needs to be generated again from the beginning whenever a query is input in a realistic situation in which neighbors to be searched for are added or deleted or values of the neighbors are changed.

Although there is a dynamic data structure in which real-time information is incorporated by supplementing such a problem, it is necessary to search for neighbors that are significantly less likely to be returned as the best answers because the shortest path characteristics in an obstacle environment are not considered, which leads to an excessive search time.

### PRIOR ART DOCUMENT

### Non-Patent Document

1. Xia, Chenyi, David Hsu, and Anthony K H Tung. “A fast filter for obstructed nearest neighbor queries.” British National Conference on Databases. Springer, Berlin, Heidelberg, 2004.
2. de Berg, Santa, and Frank Staals. “Dynamic Data Structures for k-Nearest Neighbor Queries.” 32nd International Symposium on Algorithms and Computation (ISAAC 2021). Schloss Dagstuhl-Leibniz-Zentrum für Informatik, 2021.

### SUMMARY

Various embodiments are directed to providing a GIS information retrieval method using a dynamic k-nearest neighbor search algorithm in an obstacle environment, which can provide a more efficient GIS geographical information retrieval function by narrowing a search range by using the shortest path characteristics between obstacles.

In an embodiment, a GIS geographical information retrieval method using a dynamic k-nearest neighbor search algorithm in an obstacle environment includes dividing a static data structure into smaller static data structures, considering obstacles as a range of angles on the basis of a query point, approximating and pre-processing the obstacles by using shortest path characteristics between the obstacles, and calculating a shortest distance from the query point to surrounding neighbors based on the approximated and pre-processed obstacles.

In the dividing of the data structure, a surrounding situation is incorporated into only some of the divided data structures, not all of static data structures, in a situation in which the surrounding neighbors are changed in real time.

The considering of the obstacles includes the assumption that convex hulls of the obstacles do not cross each other.

In the considering of the obstacles, the obstacles are represented as a continuous range of angles on the basis of a search point by substituting the obstacles with the convex hulls of the obstacles.

In the approximating and pre-processing of the obstacles, a visibility graph using vertexes of the convex hulls of the obstacles as peaks is calculated.

Furthermore, in the approximating and pre-processing of the obstacles, when the number of peaks of the vertexes of the convex hulls of the obstacles is n, a time taken to calculate the visibility graph may be determined as n log n.

In the calculating of the shortest distance, a search time is optimized by assigning priority to the surrounding neighbors based on the range of angles of the obstacles.

The GIS geographical information retrieval method using a dynamic k-nearest neighbor search algorithm in an obstacle environment according to an embodiment of the present disclosure can have the same effect as that of a dynamic data structure by dividing a static data structure into smaller structures, and can have an advantage in that it can reduce a total time required for a data structure while having the same spatial complexity and design time for the data structure as those of a static data.

Furthermore, the method has effects in that it can use the shortest path characteristics while considering obstacles as a range of angles, not discrete objects, on the basis of a query point, and can optimize a search time by assigning priority to neighbors based on the calculated range of angles.

### BRIEF DESCRIPTION OF THE DRAWINGS

FIG. 1 is a flowchart of a GIS geographical information retrieval method using a dynamic k-nearest neighbor search algorithm in an obstacle environment according to an embodiment of the present disclosure.

FIGS. 2(a) to 2(c) are diagrams simply illustrating a process of constructing an input which may be input to a computer based on actual geographical information and searching for the nearest neighbor by using the GIS geographical information retrieval method according to an embodiment of the present disclosure.

FIG. 3 is a schematic diagram illustrating a shape of a data structure that is constructed for a fast operation of a geographical information search algorithm that is proposed in an embodiment of the present disclosure.

### DETAILED DESCRIPTION

The present disclosure relates to a method for improving GIS information retrieval performance through an improved dynamic k-nearest neighbor search algorithm in an obstacle environment.

Hereinafter, geographical information retrieval refers to a function of returning a facility near a given location, among facilities that currently provide a service to be used, when a current location and the service are given.

Most of conventional neighbor search algorithms do not reflect facility information that is changed in real time, and are not efficient because the neighbor search algorithms perform unnecessary search although the neighbor search algorithms reflect the facility information.

The present disclosure provides a more efficient GIS information retrieval function by narrowing a search range by using the shortest path characteristics between obstacles.

Hereinafter, the contents of the present disclosure will be described in more detail with reference to the drawings.

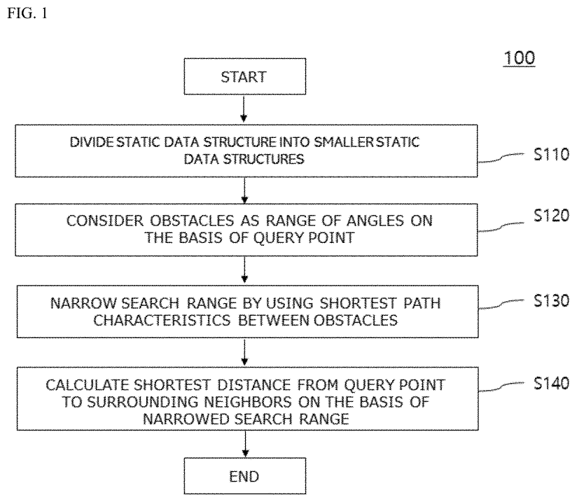

FIG. 1 is a flowchart of a method 100 of searching for, by a GIS, geographical information using a dynamic k-nearest neighbor search algorithm in an obstacle environment according to an embodiment of the present disclosure.

Referring to FIG. 1, the method 100 of searching for, by a GIS, geographical information using a dynamic k-nearest neighbor search algorithm in an obstacle environment according to an embodiment of the present disclosure includes step S110 of dividing a static data structure into smaller static data structures, step S120 of considering obstacles as a range of angles on the basis of a query point, step S130 of approximating and pre-processing the obstacles by using the shortest path characteristics between the obstacles, and step S140 of calculating the shortest distance from a query point to surrounding neighbors based on the approximated and pre-processed obstacles.

A detailed description of step S110 of dividing a static data structure into smaller static data structures to step S140 of calculating the shortest distance illustrated in FIG. 1 is as follows.

In step S110 of dividing a data structure, points, that is, neighbor search targets, are not considered as one set, but are divided into smaller sets, thus constructing a data structure. That is, a static data structure is divided into smaller static data structures in order to have the same effect as that of a dynamic data structure.

In this case, corresponding data structures are designed to support fast search for the nearest neighbor even in a dynamic situation in which neighbor search target points are added. Accordingly, there is an effect in that the time taken to search for the nearest neighbor can be finally reduced by applying, to each of the data structures, the shortest distance algorithm to be subsequently presented in step S140 of calculating the shortest distance.

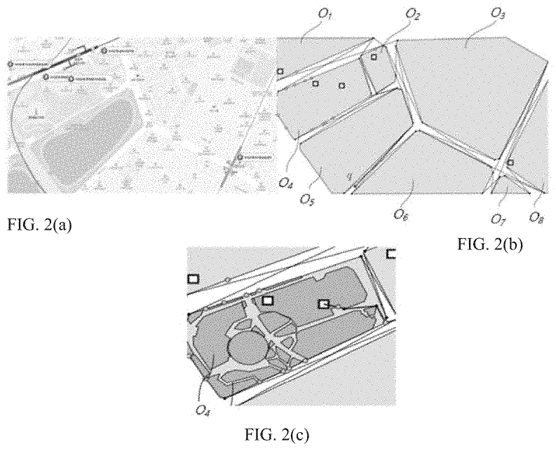

FIGS. 2(a) to 2(c) are diagrams simply illustrating a process of constructing an input which may be input to a computer based on actual geographical information and searching for the nearest neighbor by using the GIS geographical information retrieval method according to an embodiment of the present disclosure. For example, FIGS. 2(a) to 2(c) illustrate a process of searching for a location of the nearest bank from a query point when geographical information around Jamsil Lotte Tower in Seoul and the query point are given.

FIG. 2(a) is a diagram illustrating the locations of a map and banks around Jamsil Lotte Tower in Seoul. In FIG. 2(b), obstacles (e.g., a building and a lake) are represented as convex hulls, which are indicated as O₁, O₂ to O₈, respectively. The location of the bank is indicated as a square point, and a query point is indicated as “q”. In this case, the nearest obstacle, among the obstacles including the banks, is searched for, and the obstacle O₄ is selected.

FIG. 2(c) illustrates internal structures of the obstacle O₄. The nearest bank is searched for within the obstacle O₄.

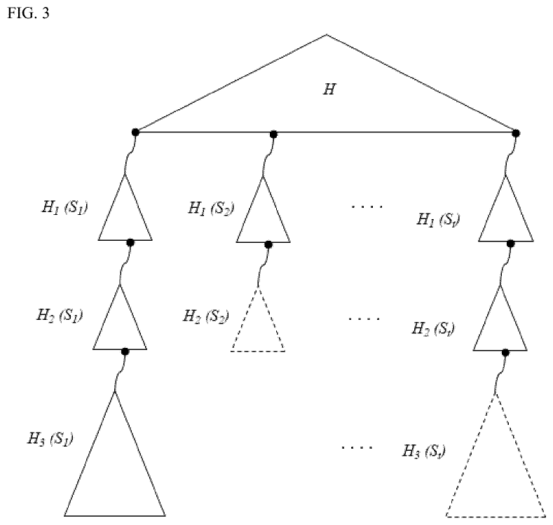

FIG. 3 is a schematic diagram illustrating a shape of a data structure that is constructed for a fast operation of a geographical information search algorithm that is proposed in an embodiment of the present disclosure.

Step S110 of dividing a data structure may be implemented as a programming code based on <Pseudo code 1> and <Pseudo code 2>.

<Pseudo code 1>
Algorithm initializeDataStructure(S, O)

| | Input : A set S of points and a set O of polygon obstacles wherein the number of points is n |
|---|---|
| | Output : A set of data structures DS for a k-nearest neighbor query based on S, O |
| 1: | initialize DS = Ø |
| 2: | initialize to i = 1 |
| 3: | decrease from for j=log n to 1 |
| 4: | if [symbol] S [symbol] ≥ 2^{j} |
| 5: | produce a subset S [symbol] of S having a size of 2^{j} |
| 6: | DS ← DS ∪ constructDataStructure(S [symbol] , O) |
| 7: | S ← S\S [symbol] |
| 8: | [symbol] ← [symbol] + 1 |
| 9: | end if |
| 10: | end for |
| 11: | return DS |

[symbol]

indicates data missing or illegible when filed

<Pseudo code 2>
Algorithm insertDataStructure(q)

| | Input : data structures for a query DS [symbol] , ... , DS [symbol] a point to be |
|---|---|
| | inserted |
| | Output : data structures including q DS [symbol] , ... , DS [symbol] |
| 1: | DS [symbol] ← initializeDataStructure({q}, O) |
| 2: | initialize to i = 1 |
| 3: | while |
| 4: | if \|DS [symbol] \| ≠ \|DS [symbol] \| |
| 5: | break |
| 6: | DS [symbol] ← initializeDataStructure({q}, O) |
| 7: | end if |
| 8: | DS [symbol] ← initializeDataStructure(S [symbol] ∪ S [symbol] , O) |
| 9: | i = i + 1 |
| 10: | end while |
| 11: | from for j = 1 to t |
| 12: | DS [symbol] ← DS [symbol] |
| 13: | end for |
| 14: | return DS [symbol] , . . . , DS [symbol] |

[symbol]

indicates data missing or illegible when filed

In step S120 of considering obstacles, the obstacles are considered as a range of an angle based on a query point. In this case, assuming that the convex hulls of obstacles, such as a building and a house in most cases of real life, do not cross each other based on the ideas that the convex hulls do not cross each other, each obstacle is substituted with its convex hull. By substituting the obstacle with the convex hull, each obstacle may be represented as a continuous range of angles on the basis of a search point.

Step S120 of considering obstacles may be implemented as a programming code based on <Pseudo code 3>.

<Pseudo code 3>
Algorithm constructDataStructure(S, O)

| | Input : a set S of points, a set O of polygon obstacles |
|---|---|
| | Output : a data structures DS for a k-nearest neighbor query based |
| | on S, O |
| 1: | initialize structure DS |
| 2: | initialize a set of convex hulls of obstacle O′ = Ø |
| 3: | for each obstacle o ∈ O |
| 4: | calculate convex hulls o′ of o |
| 5: | connect o and o′ by pointer |
| 6: | O′ ← O′ ∪ {o′} |
| 7: | end for |
| 8: | calculate a visibility graph VG based on vertexes of O′ and s |
| 9: | store information on S, O, O′, VG |
| 10: | return DS |

In step S130 of approximating and pre-processing the obstacles, the obstacles are approximated and pre-processed by using the shortest path characteristics between the obstacles. In particular, in this step, an algorithm may be designed to reduce the time taken to search for the nearest neighbor by using the shortest distance characteristics on a plane.

Specifically, a visibility graph is calculated by using, as peaks, the vertexes of the convex hulls calculated in step S120 of considering obstacles. Assuming that a total number of peaks are n in the graph in which the vertexes of convex polygons on a plane are peaks, a visibility graph may be calculated within a predetermined time corresponding to n log n. However, if the visibility graph is calculated by using the peaks of obstacles themselves not their convex hulls, the time corresponding to n\hat{ }2 is consumed assuming that the number of peaks is n.

Accordingly, an embodiment of the present disclosure can have an effect in that it can reduce the time taken to calculate a visibility graph by adding the assumption that the convex hulls of obstacles do not cross each other.

In step S140 of calculating the shortest distance, the shortest distance from a query point to surrounding neighbors is calculated based on the obstacles approximated and pre-processed in step S130 of approximating and pre-processing the obstacles, and the k-nearest neighbor is finally returned. In this case, the process of calculating the shortest distance up to the surrounding neighbors is performed by applying the shortest distance algorithm (e.g., Dijkstra's algorithm) on the visibility graph calculated in step S130 of approximating and pre-processing the obstacles.

In this case, if a site of a corresponding nearest neighbor does not belong to the convex hull of any obstacle, the distance up to the site can be rapidly calculated. If a site of a corresponding nearest neighbor belongs to the convex hull of any obstacle, a portion in which the site is present within the corresponding convex hull takes a form of a simple polygon. The algorithm operates in a way to apply the shortest distance algorithm again by adding, to the visibility graph, a portion corresponding to a simple polygon.

Step S130 of approximating and pre-processing the obstacles and step S140 of calculating the shortest distance may be implemented as programming codes based on <Pseudo code 4> and <Pseudo code 5>.

<Pseudo code 4>
Algorithm queryDataStructure(q, k)

| | Input : data structures for a query DS [symbol] , ... , DS [symbol] a query point q, the number k of query requests |
|---|---|
| | Output : a set of k points nearest to q among points of a set S=U [symbol] ^{t}=S [symbol] |
| 1: | produce a heap H in which the number of leaf nodes is t and a key of all elements is 0 |
| 2: | from for i = 1 to t |
| 3: | H [symbol] (S [symbol] ) ←getNeighbors(q, DS [symbol] 1, min(log n, \|S [symbol] \|)) |
| 4: | connect i-th leaf node of H and root node of H [symbol] (S [symbol] ) |
| 5: | end for |
| 6: | |
| 7: | produce an empty heap H′ and insert a root node of H |
| 8: | produce an array Q of empty points |
| 9: | from for i = 1 to k |
| 10: | find an element 1 having the smallest key in H′ and remove the smallest key from H′ |
| 11: | Insert q into Q |
| 12: | find a partial heap Hⱼ(Sₖ) to which q belongs in H |
| 13: | if q is a node having the greatest key in Hⱼ(Sₖ) |
| 14: | H [symbol] (S [symbol] ) ←getNeighbors(q, DS [symbol] min((2 [symbol] − 1) log n + 1 [symbol] \|S [symbol] \|), min((2^{j+1} − |
| | 1) log n, \|S [symbol] \|)) |
| 15: | connect q and the root node of H [symbol] (S [symbol] ) |
| 16: | end if |
| 17: | insert all child nodes of q into H′ |
| 18: | end for |
| 19: | return Q |

[symbol]

indicates data missing or illegible when filed

<Pseudo code 5>
Algorithm getNeighbors( [symbol] , DS, a, b)

| | Input : a start point s, a data structure DS for a k-nearest neighbor query, integers a, b |
|---|---|
| | Assumption : convex hulls of two arbitrary obstacles included in DS do not overlap |
| | Output : a min heap H in which a-th to b-th nearest neighborsfrom s are stored |
| 1: | calculate a list L in which the elements of S are arranged in order of short Euc [symbol] an from s |
| 2: | add a vertex s to a visibility graph DS, VG and add main lines adjacent to s |
| 3: | initialize to a set of points C= Ø that are likely to becomes a k-nearest neighbor |
| 4: | initialize a min heap H so that the min heap H includes b nodes having a ∞ value |
| 5: | [symbol] |
| 6: | while (a value of a b-th element of H) ≥ L[ [symbol] ], dist |
| 7: | [symbol] |
| 8: | connect a node corresponding to t in C ← C ∪ {t}, C by a pointer |
| 9: | if t is included in a convex hull o′ ∈ DS, O′ of a specific obstacle |
| 10: | invoke an obstacle o′ ∈ DS, O connected to o′ and a pointer |
| 11: | calculate a simple polygon area to which t belongs in a portion corresponding to o′−o |
| 12: | add all vertexes of the corresponding area to DS, VG as vertexes and add corresponding main lines |
| 13: | else |
| 14: | add a vertex t to DS, VG and add main lines adjacent to t |
| 15 | end if |
| 16 | while until Dijkstra's algorithm is terminated in DS, VG |
| 17: | perform Dijkstra's algorithm by one step |
| 18: | [symbol] : = (a maximum distance that is now updated) |
| 19: | if [symbol] |
| 20: | [symbol] |
| 21: | break |
| 22: | else if a distance of a node c ∈ C is updated |
| 23: | H [symbol] |
| 24 | C ← C \ [symbol] |
| 25 | end if |
| 26: | end while |
| 27: | [symbol] |
| 28: | end while |
| 29: | remove the first an elements from H |
| 30: | return H |

[symbol]

indicates data missing or illegible when filed

A GIS is an integrated system capable of effectively storing and processing all types of information on a geographic space. The GIS is used in various fields and provides knowledge for an efficient geographical distribution, which may be implemented by k-nearest neighbor search. The k-nearest neighbor search is to search for k facilities near a query point, when environment information including various types of facility information and the location of the query point are given. For example, when the nearest gas stations from a current location are searched for, the nearest k gas stations are searched for.

When there is a static data structure, the same effect as that of a dynamic data structure can be achieved by dividing the static data structure into an appropriate number of smaller static data structures. In other words, even in a situation in which neighbors are changed in real time, the same results as those of a conventional technology can be achieved only by incorporating the situation into only some of the divided data structures, not all of the data structures. In such a case, it is more efficient because the spatial complexity and design time of the data structure are asymptotically the same as those of the static data structure, but a total time required for the data structure is reduced compared to the conventional technology.

Furthermore, most of conventional algorithms do not use the shortest path characteristics between obstacles. In contrast, in an embodiment of the present disclosure, obstacles are considered as a range of angles, not discrete objects, on the basis of a query point, and the shortest path characteristics are used at the same time. Accordingly, the present disclosure optimizes a search time by assigning priority to neighbors based on the calculated range of angles.

This application claims the benefit of and priority to Korean Patent Application No. 10-2021-0185237 filed on Dec. 22, 2021, and U.S. Provisional Application No. 63/294,069 filed on Dec. 27, 2021, the entirety of each of which is incorporated herein by reference for all purposes.

Since the present disclosure may be variously modified and have various forms, specific embodiments are illustrated in the drawings and described in detail in the body. However, this is not intended to limit the present disclosure to specific disclosed forms, and should be understood to include all modifications, equivalents, and substitutes included in the spirit and technical scope of the present disclosure.

All terms used in the body including technical or scientific terms, unless otherwise defined, have the same meanings as the terms generally understood by those skilled in the art in the art to which the present disclosure pertains. Terms such as terms defined in dictionaries, which are generally used, should be interpreted as having meanings identical to contextual meanings of the related art, and are not interpreted as ideal or excessively formal meanings unless they are definitely defined in the present application.

What is claimed is:

1. A GIS (GIS) geographical information retrieval method using a dynamic k-nearest neighbor search algorithm in an obstacle environment, the method comprising:
dividing a static data structure into smaller static data structures;
considering obstacles as a range of angles on the basis of a query point;
approximating and pre-processing the obstacles by using shortest path characteristics between the obstacles; and
calculating a shortest distance from the query point to surrounding neighbors based on the approximated and pre-processed obstacles.

2. The method of claim 1, wherein in the dividing of the data structure, a surrounding situation is incorporated into only some of the divided data structures, not all of static data structures, in a situation in which the surrounding neighbors are changed in real time.

3. The method of claim 1, wherein the considering of the obstacles comprises an assumption that convex hulls of the obstacles do not cross each other.

4. The method of claim 3, wherein in the considering of the obstacles, the obstacles are represented as a continuous range of angles on the basis of a search point by substituting the obstacles with the convex hulls of the obstacles.

5. The method of claim 4, wherein in the approximating and pre-processing of the obstacles, a visibility graph using vertexes of the convex hulls of the obstacles as peaks is calculated.

6. The method of claim 5, wherein in the approximating and pre-processing of the obstacles, when a number of the peaks of the vertexes of the convex hulls of the obstacles is n, a time taken to calculate the visibility graph is determined as n log n.

7. The method of claim 1, wherein in the calculating of the shortest distance, a search time is optimized by assigning priority to the surrounding neighbors based on the calculated range of angles of the obstacles.
